(19) United States
(12) Patent Application Publication
(10) Pub. No.: US 2010/0189534 A1
(43) Pub. Date: Jul. 29, 2010

(54) METHOD AND APPARATUS FOR STORAGING AND TRANSFERRING CONTAINERS

(76) Inventor: Kyong-Ja Jung, Kyonggi-do (KR)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 11/909,768

(22) PCT Filed: Mar. 27, 2006
(86) PCT No.: PCT/KR06/01112

§ 371 Date: Sep. 26, 2007

(30) Foreign Application Priority Data
Apr. 1, 2005 (KR) 10-2005-0027630
Aug. 5, 2005 (KR) 10-2005-0071963
Aug. 5, 2005 (KR) 10-2005-0071964

(51) Int. Cl. B65G 1/06; B65G 1/04

(52) U.S. Cl. 414/281; 414/807; 414/267

(57) ABSTRACT

A method of rationally storing and transferring containers within a short time in a tower type container loading system and an apparatus using the same are disclosed. The method includes the steps of designating a position where a container to be stored is stored when the container enters a steel structure; elevating the container to a storage in a layer at the storing position along an elevation passage of the steel structure with a traveler; transferring and temporally storing the container to and in a temporary storing place positioned at the leading end of the storage when the container is positioned in the storage; and transferring and storing the container in the temporary storing place to and in a designated storing position using a transferring traveler installed in the storage.

### BACKGROUND OF THE INVENTION

1. Field of the Invention

The present invention relates to a method of storing and transferring containers in a tower type container loading system and an apparatus using the same, and more particularly, to a method of rationally storing and transferring containers within a short time in a tower type container loading system and an apparatus using the same.

2. Description of the Related Art

Generally, a container means a vessel used for effectively and economically transferring box-shaped luggage. There are various types having various lengths and heights, but a container having a length of 20 ft or 40 ft is mainly used.

The container is usually stored in specific stored in specific equipment in areas) such as a container terminal which is usually located at a port where a great deal of the containers are stored and transferred.

However, in order to store a great deal of the containers, the container terminal must be very wide, as such it is difficult to secure a wide place, and the containers are not effectively stored even when the place is wide.

Moreover, since the containers are stored in the wide place in scattered state so that the stored containers are far away from the ships, a transferring apparatus for transferring the containers to the ships and workers for managing the apparatus are needed.

In order to solve the above-mentioned problem, this applicant has filed Korean Patent Application No. 2004-16979 (filing date: Mar. 12, 2004) entitled “Tower Type Container Storing Method and System”, and the patent application will be described with reference FIGS. 23 and 24 as follows.

As shown in the drawings, a conventional tower type container storing system is structured such that a plurality of steel structures 100a are coupled with each other to form steel storing equipment, a plurality of storages 100c are provided at the sides of vertical elevation passages 100b formed in the steel structures 100a, cages 200a are respectively elevated and lowered within the steel structures 100a, and travelers 300a travel horizontally from the cages 200a to the storages 100c.

The conventional tower type container storing system includes loaders 400a provided at the lateral sides of the steel storing equipment to insert the containers transferred from the exterior into the steel structures 100a.

Additionally, the cages 200a are elevated and lowered along vertical rails, which are respectively installed in the vertical elevation passages 100b, by a driving device including a sheave and a wire rope which are installed in the upper side of the steel structures 100a. The travelers 300a arranged in the cages 200a travel horizontally along horizontal rails 100d installed at the lateral sides of the storages 100c by motors installed in the respective travelers 300a.

The containers inserted into the steel structures 100a by the loaders 400a are held by the travelers 300a and are elevated to places where the containers are stored together with the travelers 300a in the cages 200a, and are horizontally moved to the storing positions of the storages 100c corresponding to the positions where the travelers 300a are stored so that the storage of the containers is carried out. In reverse sequence, the containers are withdrawn.

However, the above-mentioned tower type container storing system has disadvantage as follows.

Since the cage stops while the traveler stores the container in the storage or withdraws the container from the storage, the utility of the system is inferior and it takes a very long time for storing and withdrawing the containers.

Moreover, since the height of the storages is low, in order to withdraw containers in the central area of the system, the containers in front of the container in the central area must to be transferred to another place. Thus, the efficiency of storing and transferring the containers is remarkably inferior.

Meanwhile, in the above-mentioned tower type container storing system, as the number of the containers to be stored is gradually increased, the storages between the vertical elevation passages are increased in the width direction so that the storing and transferring speed of the containers and the efficiency are deteriorated.

Described in more detail, in the conventional tower type container storing system, there are no storages in the lowermost layer, carts travel only along the vertical elevation passages, the cages are provided in every section of the storages positioned in the lateral direction of the vertical elevation passages, and the travelers of the cages cannot travel horizontally in the lowermost layer.

Thus, in a case that at least two cages are provided in one vertical elevation passage where a single cart for transferring a container to the cage is provided, only a cage where the cart is positioned is operated and the other cage is stopped.

Meanwhile, in the conventional tower type container storing system, since the loaders wind and release the wire rope to elevate and lower the containers, the container hung by the wire rope may be swung right to left by external natural circumstances, that is, wind.

Moreover, since the conventional loader holds the container and rotates the held container horizontally, the container does not stop at a desired position. Thus, it is inconvenient and difficult to use.

### SUMMARY OF THE INVENTION

Therefore, the present invention has been made in view of the above-mentioned problems, and an aspect of the present invention is to provide a method of rationally storing and transferring containers within a very short time and an apparatus using the same.

Another aspect of the present invention is to provide a method of rationally storing and transferring containers using a device ready to be used by checking whether or not all devices are out of order, and an apparatus using the same.

Still another aspect of the present invention is to provide an apparatus for storing and transferring containers in which storages are increased to increase storing efficiency and utility of the apparatus.

Still another aspect of the present invention is to provide an apparatus for storing and transferring containers in which containers are easily moved in vertical direction in storages by a simple structure.

Still another aspect of the present invention is to provide an apparatus for storing and transferring containers in which a stopped cage is effectively operated.

Still another aspect of the present invention is to provide an apparatus for storing and transferring containers in which a loader is not swung by wind and can move laterally and vertically and can twist.

In accordance with one aspect, the present invention provides a method of storing and transferring containers in a tower type container storing system including the steps of: designating a position where a container to be stored is stored when the container enters a steel structure; elevating the container to a storage in a layer at the storing position along an elevation passage of the steel structure with a traveler; transferring and temporally storing the container to and in a temporary storing place positioned at the leading end of the storage when the container is positioned in the storage; and transferring and storing the container in the temporary storing place to and in a designated storing position using a transferring traveler installed in the storage.

Preferably, the method further includes the step of transferring the traveler at the temporary storing place to a place where the container enters through the elevation passage to transfer other containers when the container is temporally stored after the temporary storing step.

Moreover, the method further includes the step of checking whether or not a transferring traveler for transferring the container within the storage is out of order after the storing position designating step.

In accordance with another aspect, the present invention provides a method of storing and transferring containers including the steps of: checking a position of a container, to be withdrawn, in a steel structure when the container to be withdrawn is designated; transferring and temporally storing the container to and in a temporary storing place positioned at the leading end of a storage using a transferring traveler installed in a storage where the container to be withdrawn is stored; lowering the container stored in the temporary storing place to a withdrawal position along the elevation passage of the steel structure using a traveler; and withdrawing the container out of the steel structure when the container is arrived at the withdrawal position at the lower end of the elevation passage of the steel structure.

Preferably, the method further includes the step of arranging other containers surrounding the container to be withdrawn by controlling the transferring traveler such that the container to be withdrawn is smoothly transferred before the step of temporally storing the container.

Moreover, the method further includes the step of checking whether or not the transferring traveler for transferring the container within the storage, where the container to be withdrawn is stored, is out of order after the step of checking the withdrawal position of the container.

In accordance with another aspect, the present invention provides a method of storing and transferring containers in a tower type container storing system, including the steps of: transferring containers to two cages which are then simultaneously elevated and lowered to store and to withdraw the containers using carts traveling along rails installed in the lower end of elevation passages, and transferring other containers to cages other than the two cages using auxiliary carts provided in the lowermost layer of storages of a steel structure and traveling along auxiliary rails parallel to the carts; and transferring containers to the auxiliary carts and the other cages by horizontally moving travelers of the other cages through auxiliary horizontal rails installed in the lowermost layer of the storages where the auxiliary carts wait.

Preferably, the containers are transferred to the other cages by outer auxiliary carts traveling along the outer auxiliary rails, which are installed in traveling paths formed in the lowermost outer side of the steel structure, parallel to the carts. The containers are transferred between the outer auxiliary carts and the other cages by which travelers of the other cages horizontally travel along outer auxiliary horizontal rails which cross over each other from the traveling paths to the lower ends of the elevation passages.

In accordance with another aspect, the present invention provides an apparatus for storing and transferring containers in a tower type container storing system, which is employed in a tower type container storing system including a tower type steel structure having a plurality of storages formed in the lateral sides of elevation passages, and travelers moving horizontally in the cage along horizontal rails in the storages. The apparatus includes a temporary storing space at the lateral sides of the storages where a container transferred by the traveler is temporally stored or a container withdrawn from the storages is temporally stored, and transferring travelers provided in the respective storages to transfer the containers stored in the temporary storing space to designated positions in the storages, to transfer the containers, to be withdrawn, in the storages to the temporary storing space, and traveling along the horizontal rails.

Preferably, the storages have expanded vertical widths such that the plural containers are stored in vertical multiple layers. Each of the transferring travelers includes a main body traveling along the horizontal rails and having driving wheels placed on the horizontal rails and a driving motor for driving the driving wheels, a gripping frame provided in the lower side of the main body and having a hook for gripping the container, and a vertical mover installed between the main body and the gripping frame to move the gripping frame in the vertical direction.

Moreover, the vertical mover includes a pair of first links having upper ends hinged to the lower lateral sides of the main body, a pair of second links having upper ends hinged to the lower ends of the first links and lower ends hinged to the upper lateral sides of the gripping frame, and a pair of hydraulic cylinders installed at an angle and having lower ends hinged to the central portions of the first links and upper ends hinged to the central portion of the main body.

Moreover, the vertical mover further includes a pair of supporting shafts hinged to the center portions of the first links to interconnect the first links horizontally and coupled with the lower ends of the hydraulic cylinders so as to be hinged.

Preferably, the vertical mover further includes a hinge shaft for horizontally connecting the first links and the second links to the hinged portions of the first links and the second links such that the lower ends of the first links are hinged to the upper ends of the second links.

Moreover, the apparatus further includes a plurality of auxiliary rails installed in the storages such that the travelers move to the lower sides of the horizontal rails corresponding to the number of the containers to be stored.

In accordance with another aspect, the present invention provides an apparatus for storing and transferring containers in a tower type container storing system, which is employed in a tower type container storing system including a tower type steel structure having a plurality of storages formed in the lateral sides of elevation passages, travelers horizontally moving in the cage along horizontal rails in the storages, carts provided in the lower ends of the elevation passages to travel along rails to transfer containers, and a loader installed outside of the steel structure to load and to unload the contained on and from the carts. The apparatus includes auxiliary rails installed in the lowermost layer of the steel structure parallel to the sides of the rails, auxiliary carts traveling along the auxiliary rails to transfer the containers, and auxiliary horizontal rails installed in the lowermost layer of the steel structure such that the travelers horizontally travel along the auxiliary rails.

Preferably, the apparatus further includes traveling paths provided outside of the steel structure parallel to the rails, outer auxiliary rails installed in the inner lower sides of the traveling paths parallel to the rails, outer auxiliary carts traveling along the outer auxiliary rails to transfer the containers, and outer auxiliary horizontal rails installed from the lowermost outer side of the steel structure to the inner sides of the traveling paths.

Moreover, the loader includes a loader main body moving along the rails by horizontal driving units, a spreader provided in the lower side of the loader main body and having a holding device, an elevation driving device for moving the spreader by a driving power, a horizontal transferring device for horizontally moving the spreader perpendicular to the loader main body, and a positioning device for fixing the spreader to the horizontal transferring device and for twisting the same.

The elevation driving device includes a pair of guide beams vertically installed at lateral lower sides of the loader main body to face each other and interconnected by supporting beams, and elevation frames elevated and lowered along the guide beams by vertically installed elevation cylinders, having rods connected to the supporting beams which are installed to the guide beams, and connected to the spreader in the lower sides thereof by wire ropes.

Moreover, the horizontal transferring device includes a pair of movable frames provided at the upper lateral sides of the elevation frames perpendicular to the elevation frames and interconnected by connection frames, and active cylinders having ends fixed to the elevation frames and other ends fixed to the elevation frames.

Moreover, the positioning device includes a pair of vertical beams integrally and vertically formed at the lower lateral sides of the connection frame to face each other and supported by horizontal supporting frame, tube cylinders provided between the vertical beams, traveling along rods in which rollers are brought into rolling contact with the vertical beams and are installed to the lateral sides of the rods, and rotation devices for fixing the tube cylinders to the spreader to rotate.

Moreover, each of the rotation devices includes a vertical rotation shaft integrally formed with the lower side of the tube cylinder, and a bearing for supporting the rotation shaft against the spreader to rotate.

### BRIEF DESCRIPTION OF THE DRAWINGS

FIG. 1 is a flowchart illustrating a method of storing and transferring containers according to a preferred embodiment of the present invention;

FIG. 2 is a flowchart illustrating a method of storing and transferring containers according another preferred embodiment of the present invention;

FIG. 3 is a schematic front sectional view of an apparatus for storing and transferring containers according to a first preferred embodiment of the present invention;

FIG. 4 is a front sectional view illustrating a main part of the apparatus for storing and transferring containers according to the first preferred embodiment of the present invention;

FIG. 5 is an enlarged view of FIG. 4;

FIGS. 6 to 8 are side sectional views of the main part of the apparatus for storing and transferring containers illustrating operation of a transferring traveler according to the first preferred embodiment of the present invention;

FIG. 9 is a front view illustrating a tower type container storing system according to a second preferred embodiment of the present invention;

FIG. 10 is a plan view of FIG. 9;

FIG. 11 is an enlarged view of a traveler in FIG. 9;

FIG. 12 is a front sectional view illustrating a main part of an apparatus for storing and transferring containers according to a third preferred embodiment of the present invention;

FIG. 13 is a perspective view illustrating a cart employed in the apparatus for storing and transferring containers according to the third preferred embodiment of the present invention;

FIG. 14 is a perspective view illustrating a main part of an apparatus for storing and transferring containers according to a fourth preferred embodiment of the present invention;

FIG. 15 is an exploded perspective view illustrating a loader main body in FIG. 14;

FIG. 16 is a perspective view illustrating an elevating frame in FIG. 14;

FIG. 17 is a perspective view illustrating a spreader in

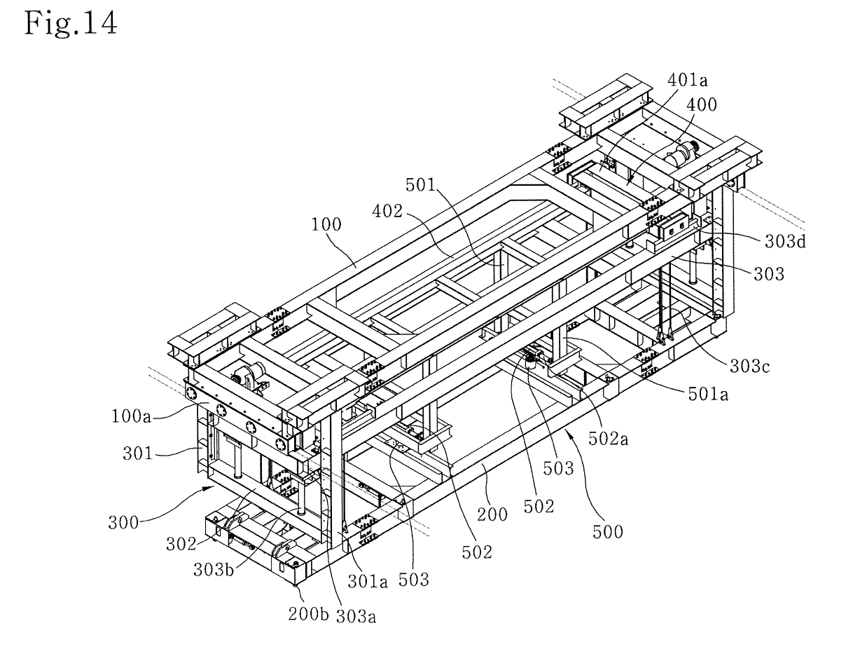

FIG. 14;

FIG. 18 is a side view illustrating an assembly of the apparatus for storing and transferring containers according to the fourth preferred embodiment of the present invention;

FIG. 19 is a plan view illustrating a positioning device according to the fourth preferred embodiment of the present invention;

FIG. 20 is a front view illustrating a positioning device according to the fourth preferred embodiment of the present invention;

FIGS. 21 and 22 are plan views illustrating operation of the spreader according to the fourth preferred embodiment of the present invention;

FIG. 23 is a schematic front sectional view illustrating a conventional tower type container storing system; and

FIG. 24 is an enlarged view of a main part of FIG. 23.

### DESCRIPTION OF THE PREFERRED EMBODIMENTS

Hereinafter, a method of storing and transferring container and an apparatus using the same according to preferred embodiments of the present invention will be described in detail with reference to the accompanying drawings.

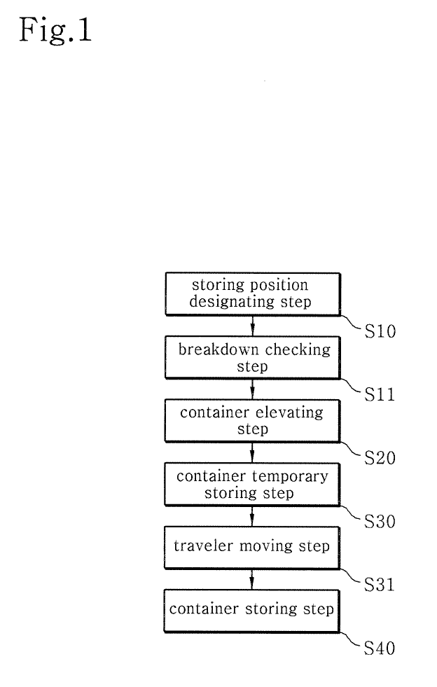

FIG. 1 is a flowchart illustrating a method of storing and transferring containers according to a preferred embodiment of the present invention.

As shown in the drawing, the method of storing and transferring containers includes the steps of designating a storing position where a container is to be stored (S10), elevating the container to the designated storing position (S20), temporally storing the container at the leading end of a storage where the container is stored (S30), and moving the temporally stored container to the storing position to store (S40).

The step of designating a storing position (S10) means a process of designating a position where the container is to be stored when the container to be stored enters a steel structure, that is, of designating the position where the container is to be stored by searching for an empty place within the steel structure using a controlling unit provided in an apparatus for storing and transferring containers.

Moreover, the step of elevating the container (S20) means a process of elevating the container to a layer where the container is stored to transfer the container to the designated storing position along the elevation passage of the steel structure using a traveler. In this step, the container entering the lower side of the steel structure is held by the traveler and the traveler is elevated to a storage where the designated storing position is located, by a cage, so that the container is elevated to a layer where the container is to be stored.

The step of temporally storing the container (S30) means a process of transferring the container to a temporary storing place positioned at the leading end of the layer where the container is to be stored and of storing the container when the container is positioned in the layer where the container is to be stored. In this step, the traveler holding the container directly stores the held container in the empty temporary storing place without the movement to the storing position.

As such, the container is temporally stored so that the traveler unloads the container such that it can be used in other task. Thus, the utility of the traveler is improved.

Moreover, the step of storing the container (S40) means a process of transferring the container stored in the temporary storing place to the designated storing position by a transferring traveler installed in the storage and storing the same. In this step, the container temporally stored in the temporary storing place is transferred to and stored in the designated storing position by the transferring traveler installed in the storage.

As such, since the container is temporally stored such that the elevation and transfer of the container into the storage to store the container are independently carried out, the cage traveling vertically along the vertical passage and the traveler can be effectively used and the container is more easily transferred to the storing position.

Moreover, after the step of temporally storing the container (S30), there is provided a sub-step of transferring the traveler in the temporary storing place to a place where the container enters through the elevation passage for transferring other containers when the temporary storing of the container is completed (S31).

In the sub-step (S31), after the temporary storing of the container is completed, the traveler is directly transferred to the place where the container enters which is located in the lower side of the steel structure so that the utility of the traveler is remarkably increased and a great deal of containers can be stored at higher speed.

Moreover, after the step of designating a storing position (S10), there is provided a sub-step of checking whether or not the transferring traveler for transferring the container within the storage is out of order (S11).

In the sub-step (S11), whether or not the transferring traveler for transferring the container into the storage is out of order is checked so that the storing of the containers is precisely and stably carried out.

In other words, when the transferring traveler in the storage is checked and determined to be out of order, the container held by the traveler is no longer stored in the temporary storing place but is moved directly the storing position by the traveler so that the container is precisely stored.

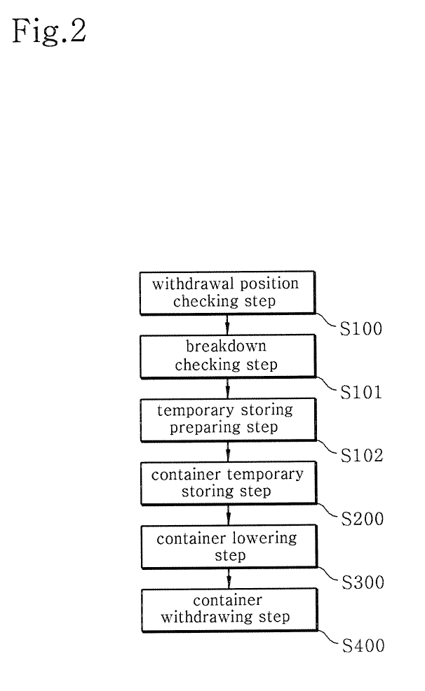

FIG. 2 is a flowchart illustrating a method of storing and transferring containers according another preferred embodiment of the present invention.

As shown in the drawing, the method of storing and transferring containers includes the steps of checking a position of a container to be withdrawn (S100), transferring the container stored in the storage and temporally storing the container for the withdrawal of the container (S200), lowering the temporally stored container using the traveler (S300), and withdrawing the lowered container out of the steel structure (S400).

The step of checking the position of the container to be withdrawn (S100) means a process of checking the position of the container, to be withdrawn, in the steel structure when the container to be withdrawn is designated. In this step, a worker selects the container to be withdrawn and a controller searches for the position where the designated container is stored and checks the position of the container.

Moreover, the step of temporally storing the container (S200) means a process of transferring the container to the temporary storing place positioned at the leading end of the storage using the transferring traveler installed in the storage and of storing the transferred container. In this step, the transferring traveler holds the stored container and transfers the held container to the temporary storing place positioned at the leading end of the storage to temporally store the container, to be withdrawn, in this place.

Moreover, the step of lowering the container (S300) means a process of lowering the container stored in the temporary storing place along the elevation passage of the steel structure using the traveler. In this step, the container stored in the temporary storing place and to be withdrawn is held by the traveler provided in the cage and is transferred to a withdrawal place positioned at the lower side of the steel structure through the elevation passage.

Moreover, the step of withdrawing the container (S400) means a process of withdrawing the container out of the steel structure when the container arrives at the withdrawal position at the lower side of the elevation passage of the steel structure. In this step, the container placed at the withdrawal position of the lower side of the elevation passage is withdrawn out of the steel structure by a cart or a trailer.

Moreover, before the step of temporally storing the container (S200), there is provided a sub-step of controlling the transferring traveler to arrange other containers surrounding the container to be withdrawn for the convenient transfer of the container (S102).

In the sub-step of preparing the storing (S102), when the container to be withdrawn is difficult to directly transfer due to other containers, the other containers around the container to be withdrawn are arranged, that is, re-positioned such that the container to be withdrawn is easily transferred.

Moreover, after the step of checking the withdrawal position (S100), there is provided a sub-step of checking whether or not a transferring traveler for transferring the container to be withdrawn from the storage is out of order (S101).

In the sub-step of checking whether or not the transferring traveler is out of order (S101), whether or not the transferring traveler in a layer where the container is to be withdrawn from is out of order is checked such that the container can be stably and precisely withdrawn.

In other words, when the transferring traveler in the storage is checked and determined to be out of order, the transferring traveler is not used but the container to be withdrawn is held directly by the traveler such that the container is not stored in the temporary storing place but is directly transferred to the withdrawal position through the elevation passage.

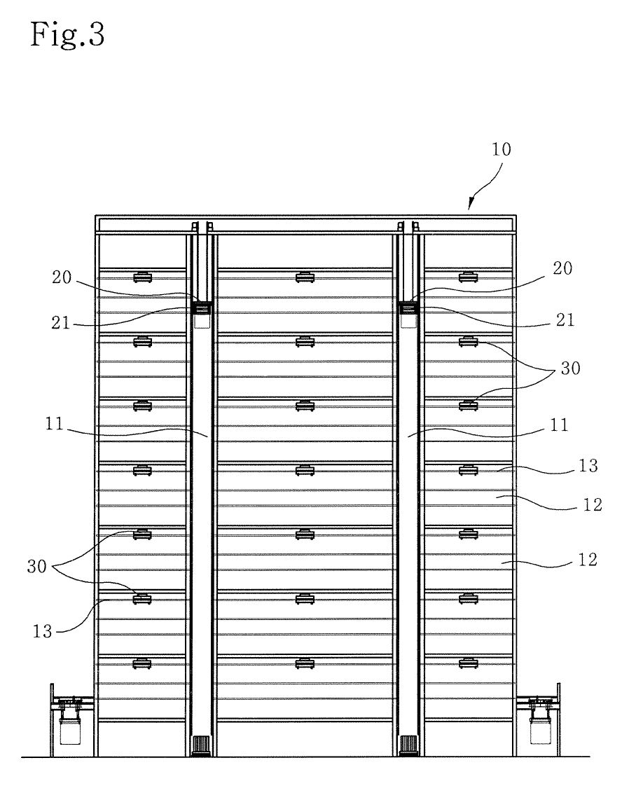

FIG. 3 is a schematic front sectional view of an apparatus for storing and transferring containers according to a first preferred embodiment of the present invention.

As shown in the drawing, the apparatus for storing and transferring containers includes a steel structure 10 having a plurality of storages 12 arranged at the lateral sides of elevation passages 11, cages 20 traveling vertically along the elevation passages 11 and having travelers 21 that are provided therein, and transferring travelers 30 installed in the respective storages 12.

The steel structure 10 includes the plurality of elevation passages 12 vertically formed in the steel structure 10, the plurality of storages 12 horizontally communicated with the lateral sides of the elevation passages 11, and horizontal rails 13 installed in the storages 12.

The storages 12 are places where a plurality of containers is stored to be stacked in the vertical direction. The horizontal rails 13 serve as passages along which the travelers 21 travel within the storages 12 and the transferring travelers 30 installed in the storages 12 travel.

Moreover, the cages 20 are elevated and lowered along the elevation passages 11, and include the travelers 21 arranged therein to move horizontally. The travelers 21 are structured to be positioned in the cages and to travel into the storages 12 along the horizontal rails 13.

In the apparatus for storing and transferring container structured as described above, when the container enters the lower side of one of the elevation passages 11, the traveler 21 holds the entered container and the cage 20 is elevated to a storing position along the elevation passage 11, and the traveler 21 holding the container travels along the horizontal rail 13 to temporally store the container at the leading end of the storage 12.

The temporally stored container is held by the transferring traveler 30 installed in the storage 12 and is transferred to a designated storing position along the horizontal rail 13 to be stored.

Oppositely, when the container is withdrawn, the transferring traveler 30 at a withdrawal position transfers the container to be withdrawn to the leading end of the storage 12 to temporally store the container, the temporally stored container is held by the traveler 21 of the cage 20 and is lowered down together with the cage 20 to the lower side of the elevation passage 11, then the container is withdrawn.

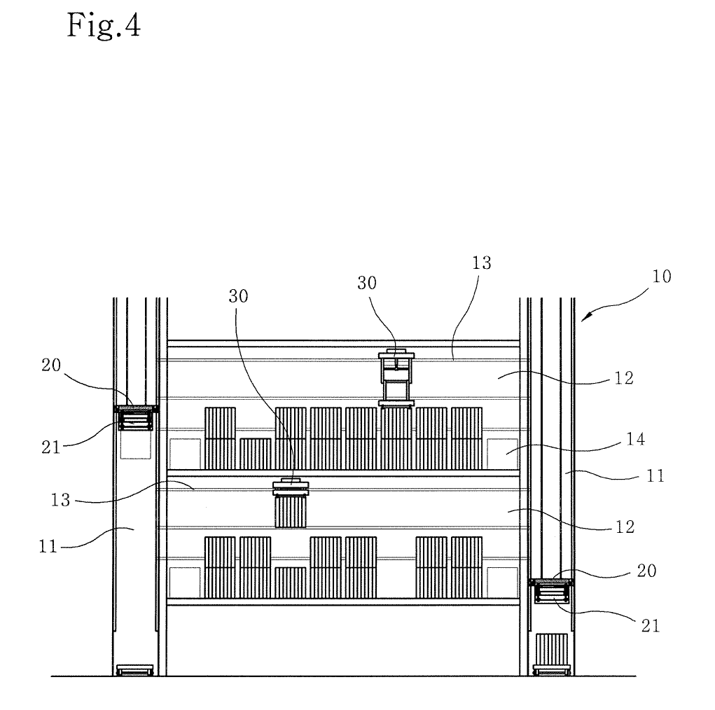

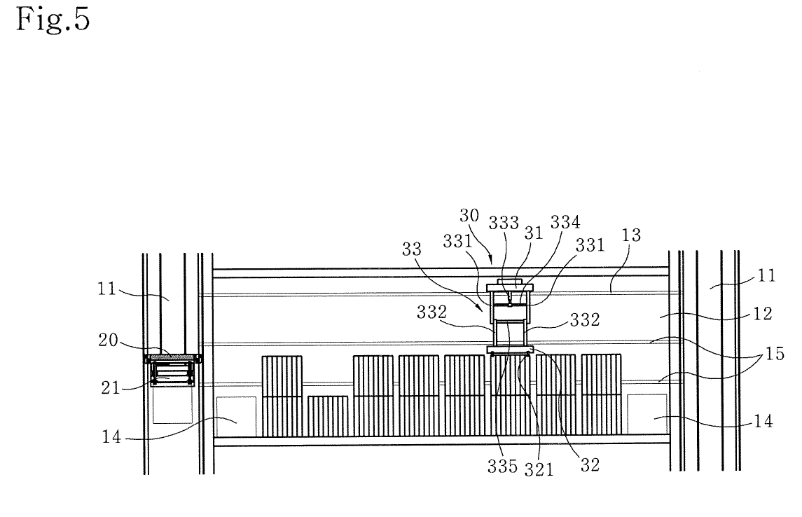

FIG. 4 is a front sectional view illustrating a main part of the apparatus for storing and transferring containers according to the first preferred embodiment of the present invention, and FIG. 5 is an enlarged view of FIG. 4.

As shown in the drawings, the apparatus for storing and transferring containers includes a steel structure 10 having a plurality of storages 12 arranged at the lateral sides of elevation passages 11, cages 20 traveling vertically along the elevation passages 11 and having travelers 21 that are provided therein, and transferring travelers 30 installed in the respective storages 12.

The steel structure 10 includes the plurality of elevation passages 11 vertically formed in the steel structure 10, the plurality of storages 12 horizontally communicated with the lateral sides of the elevation passages 11, horizontal rails 13 installed in the storages 12, temporary storing rooms 14 formed at the lateral sides of the storages 12, and a plurality of auxiliary rails 15 installed in the lower sides of the horizontal rails 13.

The storages 12 have extended vertical widths such that the plural containers are stored in the vertical direction and a number of the auxiliary rails 15 are installed in the lower sides of the horizontal rails 13 corresponding to the number of the containers to be stored.

Due to the auxiliary rails 15, the travelers 21 of the cages 20 move into the storages 12 directly along the auxiliary rails 15 to store and withdraw the containers when the transferring travelers 30 are out of order.

The temporary storing rooms 14 are formed at the lateral sides of the storages as empty spaces where the containers transferred by the travelers 21 and the transferring travelers 30 are temporally stored when the containers are stored or the stored containers are withdrawn.

As such, the containers to be stored or withdrawn are temporally stored in the temporary storing rooms 14 so that the vertical movement of the containers along the elevation passages 11 by the cages 20 and the lateral movement of the containers by the transferring travelers 30 are individually carried out. Thus, the cages 20 and the transferring travelers 30 can be independently operated so that the utility of the apparatus is increased and the speed of storing and withdrawing the containers is increased.

In other words, during the transfer of the containers by the cages 20, the transferring travelers 30 can perform other tasks, like this, the cages 20 can perform other tasks during the operation of the transferring travelers 30. Thus, the utility of the apparatus is increased.

Moreover, each of the transferring travelers 30 includes a main body 31 including driving wheels, placed on the horizontal rails 13 and a driving motor for driving the driving wheels, that travel along the horizontal rails 13, a gripping frame 32 provided in the lower side of the main body 31 and having a hook 321 for gripping the containers, and a vertical mover 33 installed between the main body 31 and the gripping frame 32 to move the gripping frame 32 vertically.

The gripping frame 32 holds the containers using the hook 321 or releases the containers.

The vertical mover 33 includes a pair of first links 331 having upper ends hinged to the lower lateral sides of the main body 31, a pair of second links 332 having upper ends hinged to the lower ends of the first links 331 and lower ends hinged to the upper lateral sides of the gripping frame 32, and a pair of hydraulic cylinders 333 installed at an angle and having lower ends hinged to the central portions of the first links 331 and upper ends hinged to the central portion of the main body 31.

The vertical mover 33 moves the gripping frame 32 vertically in the lower side of the main body 31 such that the plural containers can be easily stacked and stored in the storages 12.

Moreover, the vertical mover 33 further includes a pair of supporting shafts 334 hinged to the center portions of the first links 331 to interconnect the first links 331 horizontally and coupled with the lower ends of the hydraulic cylinders 333 to be hinged, and a hinge shaft 335 for horizontally connecting the first links 331 and the second links 332 to the hinged portions of the first links 331 and the second links 332 such that the lower ends of the first links 331 are hinged to the upper ends of the second links 332.

The supporting shafts 334 and the hinge shaft 335 support the first links 331 and the second links 332 and securely couple the same with each other so that they can be rotated.

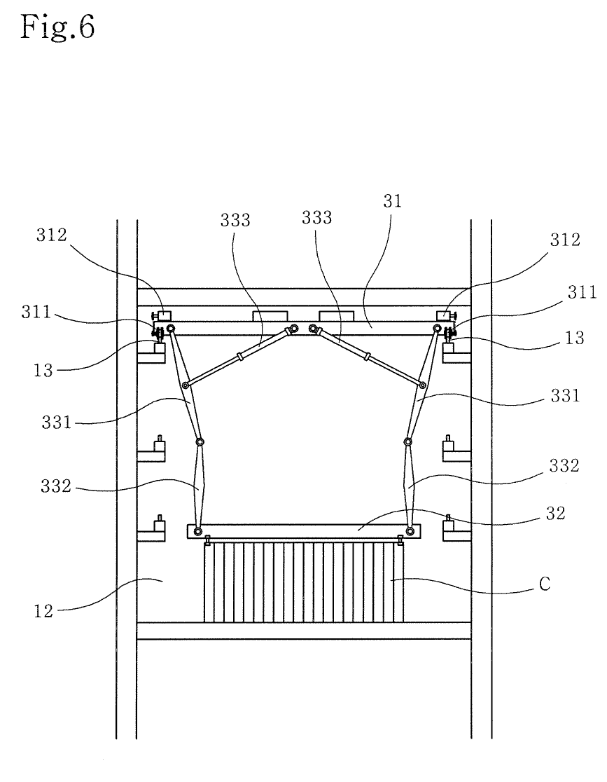

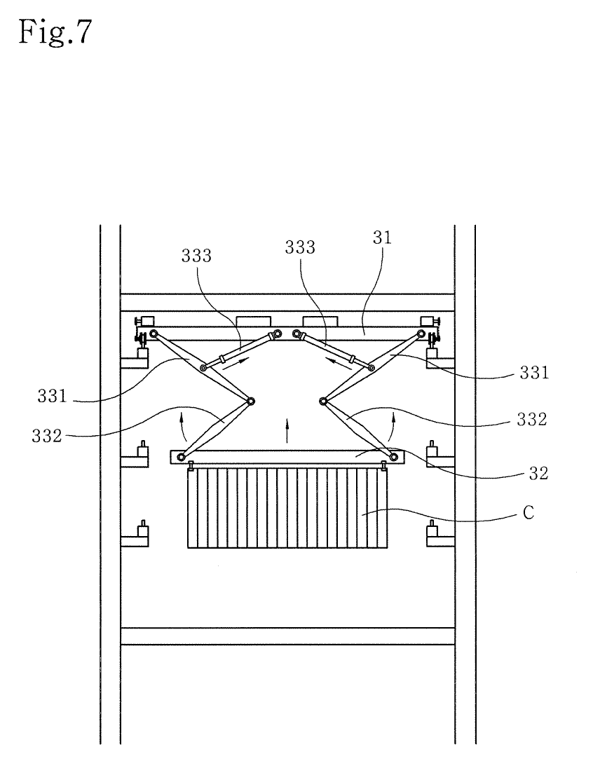

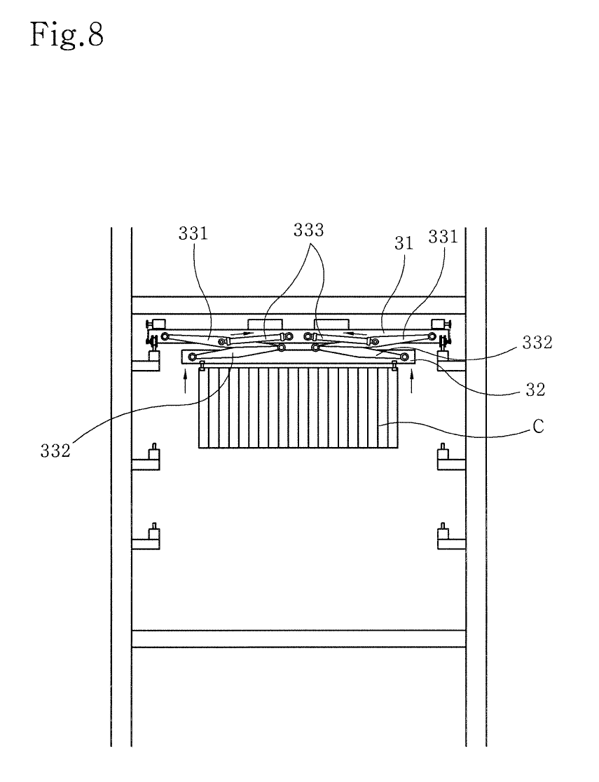

FIGS. 6 to 8 are side sectional views of the main part of the apparatus for storing and transferring containers illustrating operation of a transferring traveler according to the first preferred embodiment of the present invention.

As shown in the drawings, the main body 31 moves along the horizontal rails 13 within the storages 12 while the driving wheels 311 are rotated by the driving motor 312.

When the hydraulic cylinders 333 hinged between the main body 31 and the first links 331 start to operate, the gripping frame 32 hinged to the lower ends of the second links 332 moves vertically while the first links 331 and the second links 332 hinged thereto are folded toward the lower surface of the main body 31 or unfolded from the lower surface.

In other words, when the hydraulic cylinders 333 operate, the first links 331 and the second links 332 are folded and the gripping frame 32 gripping the container C moves toward the lower surface of the main body 31 so that the container C is elevated.

Oppositely, when the hydraulic cylinders 333 operate, the first links 331 and the second links 332 are unfolded and the gripping frame 32 gripping the container C moves from the lower surface of the main body 31 to the lower side of the main body 31 so that the container C is lowered.

As such, the first links 331 and the second links 332 are folded or unfolded by the hydraulic cylinders 333 so that the plural containers C are stored in the storages 12 or the containers C stored in the storages 12 are withdrawn.

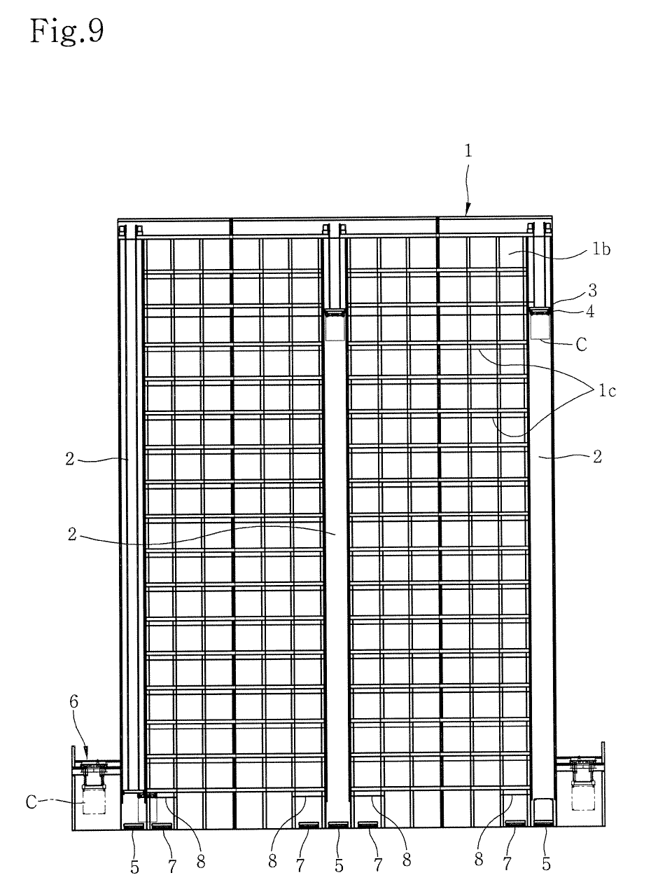

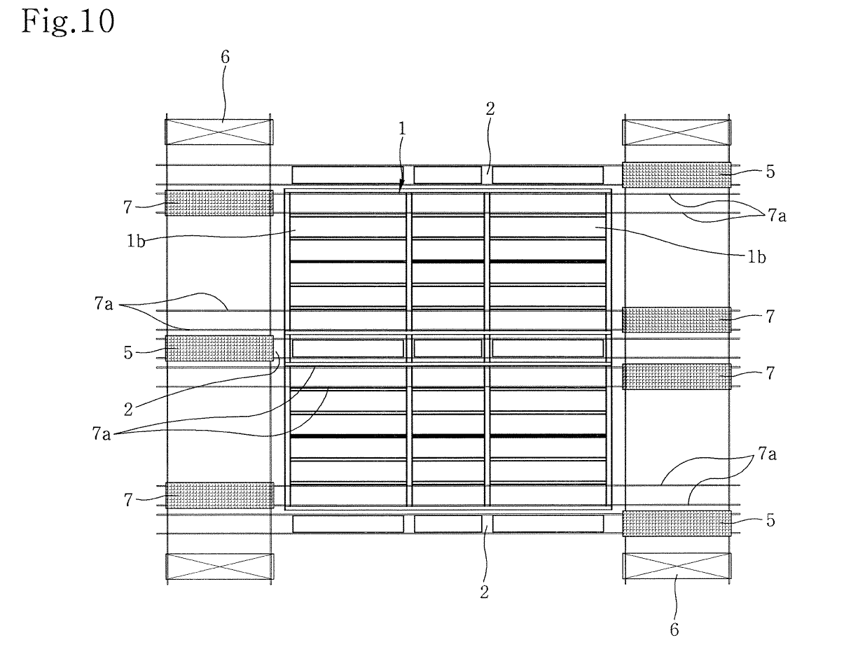

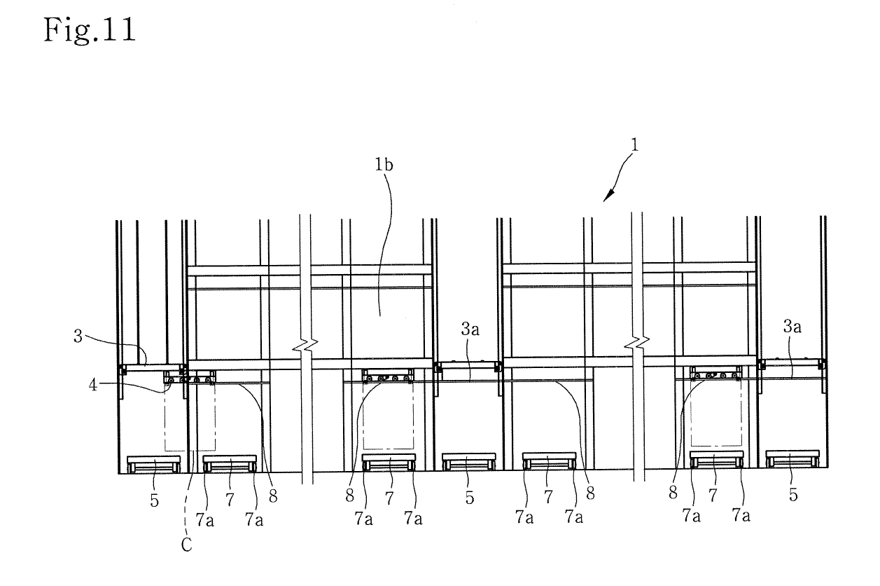

FIG. 9 is a front view illustrating a tower type container storing system according to a second preferred embodiment of the present invention, FIG. 10 is a plan view of FIG. 9, and FIG. 11 is an enlarged view of a traveler in FIG. 9.

As shown in the drawings, the tower type container storing system, like the conventional system, includes a steel structure 1 having a plurality of storages 1b, vertical elevation passages 2 formed between the storages 1b, cages 3 vertically moved along the elevation passages 2 by driving power, and travelers 4 traveling along horizontal rails 1c installed in the storages 1b by their own driving power.

Moreover, the cages 3 include corresponding horizontal rails 3a corresponding to the horizontal rails 1c in the storages 1b. The travelers 4 include holding devices (not shown) inserted into and locked by slots formed in respective upper corners of the containers C such that the containers C can be fixed to the travelers 4 by the holding devices.

In the lateral sides of the elevation passages 2, there are provided loaders 6 for loading and unloading the containers, loaded on trailers, on carts 5 traveling along the elevation passages 2. Like the travelers 4, the loaders 6 are structured to travel along guide rails perpendicular to the elevation passages 2 through a plurality of wheels driven by a motor.

In a method of storing and transferring containers using the tower type container storing system, the carts 5 in the elevation passages 2 control the cages 3 for storing the containers and the cages 3 lowered to withdraw the containers, and the remains of the cages 3 are driven to store and withdraw containers by auxiliary carts 7 traveling along auxiliary rails 7a installed in the lowermost layer of the storages 1b to be parallel to the elevation passages 2. The travelers 4 of the cages 3 are horizontally driven along auxiliary horizontal rails 8 installed in the lowermost layer of the steel structure 1 such that the containers C loaded on the auxiliary carts 7 are transferred.

An apparatus for storing and transferring containers includes the auxiliary rails 7a installed in the lowermost layer of the steel structure separately from the carts 5 traveling along the elevation passages 2, the auxiliary carts 7 being installed on the auxiliary rails 7a to travel parallel to the elevation passages 2, and the auxiliary horizontal rails 8 provided in every lowermost layer of the steel structure such that the travelers 4 of the cages 3 horizontally travel.

In the apparatus, the containers C loaded on the trailers entered from the exterior are loaded on the carts 5 in the elevation passages 2 by the loaders 6, the carts 5 travel along the elevation passages 2 and the lower sides of the elevation passages 2 where the storages 1b are positioned, the cages 3 installed in the elevation passages 2 are lowered to fix the containers C loaded on the carts 5 with the travelers 4, and then the containers C are elevated to the layers where the corresponding storages 1b are positioned.

The carts 5 move to the positions of other cages 3 lowered to receive the withdrawn containers C and wait, when the containers C, lowered to be withdrawn by the cages 3, are loaded on the carts 5, the carts 5 travel along the elevation passages 2 again and stop at the positions of the loaders 6 so that the containers C are withdrawn by the loaders 6.

Moreover, when the containers are stored and withdrawn by the carts 5, the auxiliary carts 7 receive the containers C from the trailers through the loaders 6 and travel along the auxiliary rails 7a installed in the lowermost layer of the steel structure 1, and then stop at the lowermost layer of the corresponding elevation passages 2, that is, the elevation passages 2 where other cages 3 that are not elevated or lowered stop for the storing or the withdrawal of the containers.

Thus, the cages 3 are lowered down to the lowermost layer along the elevation passages 2, and after the cages 3 are lowered down, as shown in FIG. 11, the travelers 4 of the cages 3 horizontally travel along the auxiliary horizontal rails 8 to fix the containers C loaded on the carts 5.

Next, the travelers 4 return along the auxiliary horizontal rails 8 in holding the containers C and move inside the cages 3 in the elevation passages 2. Thus, the containers are stored by the elevation of the cages 3, or are withdrawn by the lowering of the cages 3 so that all the containers C do not stop but are smoothly processed.

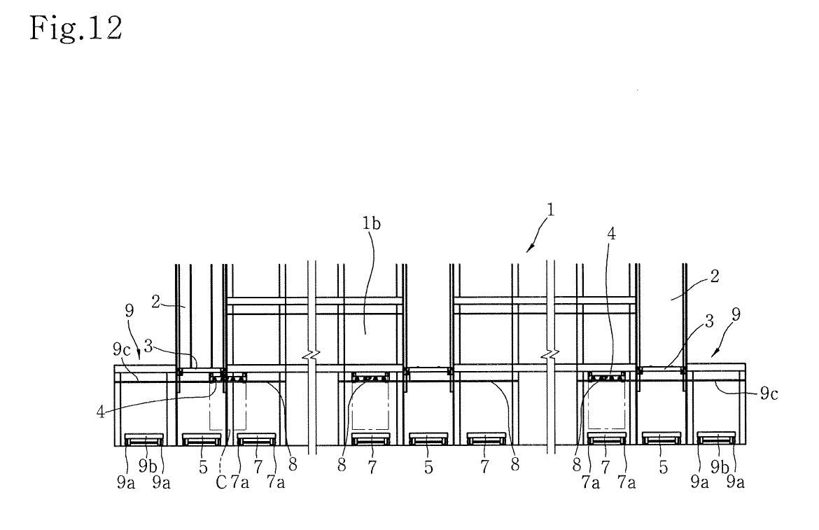

FIG. 12 is a front sectional view illustrating a main part of an apparatus for storing and transferring containers according to a third preferred embodiment of the present invention.

As shown in the drawing, the apparatus for storing and transferring containers further includes traveling paths 9 installed at outer sides of the lowermost layer of the steel structure.

The traveling paths 9 include outer auxiliary rails 9a installed on the bottoms in the traveling paths 9 parallel to the auxiliary rails 7a, and outer auxiliary carts 9b traveling along the outer auxiliary rails 9a.

Additionally, the outer auxiliary rails 9a are installed between the traveling paths 9 and the elevation passages 2, and the outer auxiliary horizontal rails 9c are structured such that the travelers 4 of the cages 3 provided in the elevation passages 2 travel horizontally and are positioned in the upper sides of the traveling paths 9.

The travelers 4 lift the containers C loaded on the outer auxiliary carts 9b positioned on the outer auxiliary rails 9a of the traveling paths 9 and transfer the same to the elevation passages 2 so that the containers C can be transferred into the storages 1b by the cages 3 or it is possible for the unloading of the containers that the containers C lowered from the storages 1b by the cages 3 are transferred to the outer auxiliary carts 9b.

Thus, the outer auxiliary carts 9b, like the carts 5 and the auxiliary carts 7, store and withdraw the containers C to and from the travelers 4 of the cages 3 so that the cages 3 are prevented from stopping and continuous operation of the apparatus is possible.

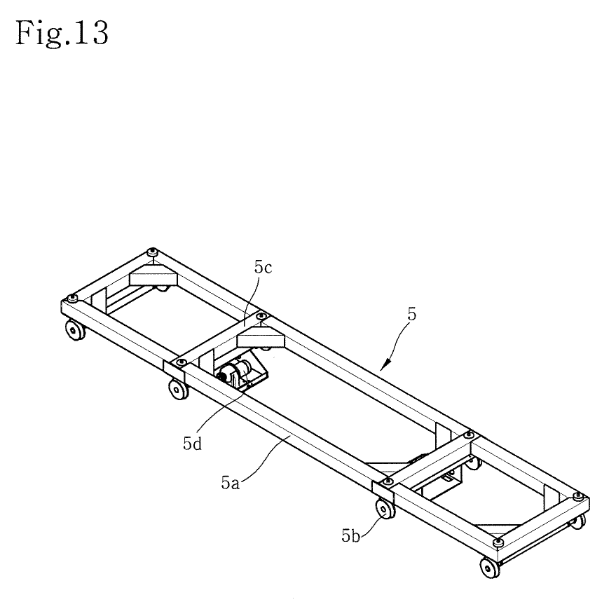

FIG. 13 is a perspective view illustrating a cart employed in the apparatus for storing and transferring containers according to the third preferred embodiment of the present invention. As shown in the drawing, the carts 5 are structured such that a pair of supporting beams 5c is installed at approximately central positions of a frame 5a equipped with wheels 5b, so that containers (length: about 40 ft) having a length corresponding to the length of the frame 5a and containers (length: about 20 ft) corresponding to an area between the supporting beams 5c can be used. This is like the auxiliary carts and the outer auxiliary carts. Here, reference numeral 5d is designated to a driving motor for driving the wheels 5b.

FIG. 14 is a perspective view illustrating a main part of an apparatus for storing and transferring containers according to a fourth preferred embodiment of the present invention.

As shown in the drawing, the apparatus for storing and transferring containers includes a loader main body 100 moved along rails by horizontal driving units 100a installed at the lateral sides thereof and a spreader 200 installed in the lower side of the loader main body 100 and having a holding device 200b.

Moreover, the apparatus further includes an elevation driving device 300 vertically moved by the driving power of the spreader 200, a horizontal transferring device 400 horizontally moved perpendicular to the loader main body 100 by the driving power of the spreader 200, and a positioning device 500 for fixing the spreader 200 to the horizontal transferring device 400 and twisting the same.

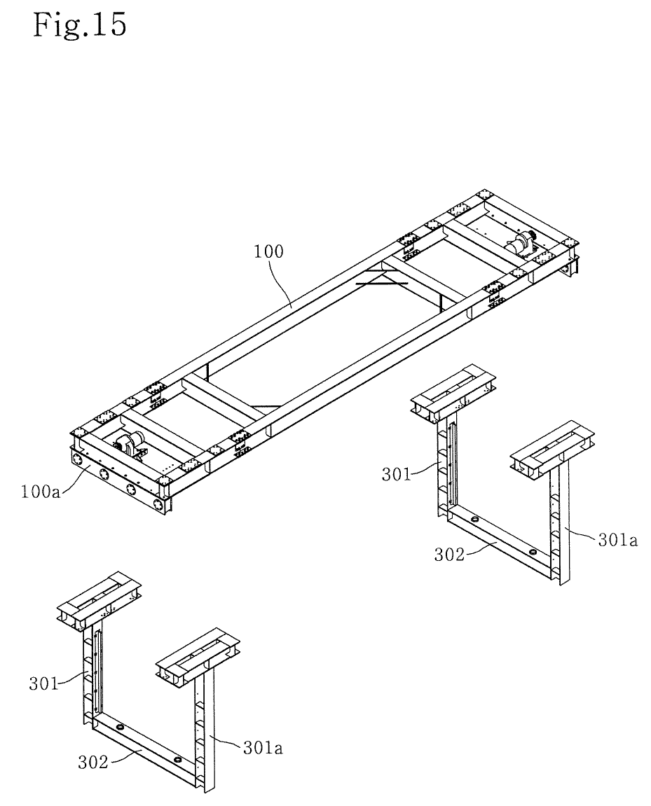

The elevation driving device 300, as shown in FIGS. 14 and 15, includes a pair of guide beams 301 and 301a vertically installed at lateral lower sides of the loader main body 100 to face each other. The lower sides of the guide beams 301 and 301a are interconnected by horizontal supporting beams 302.

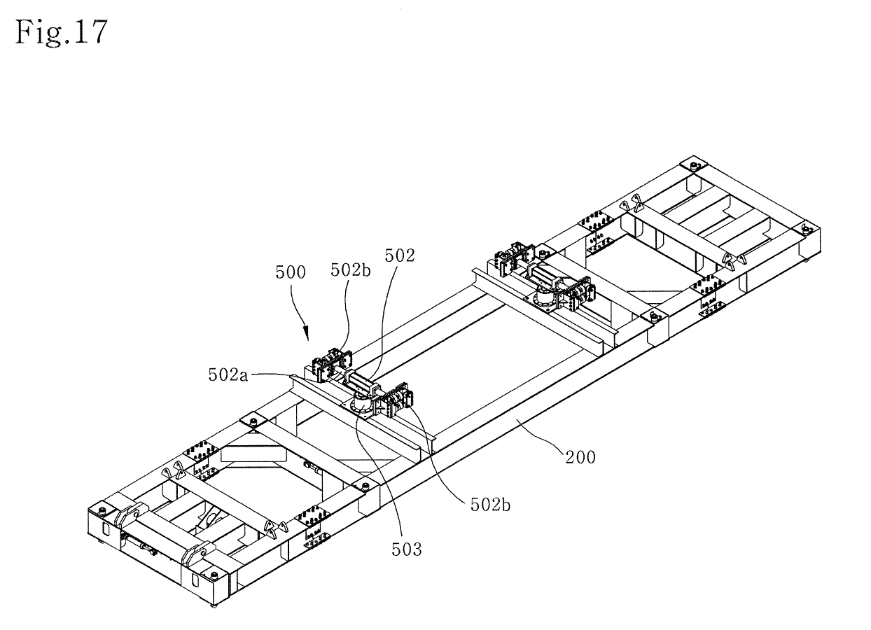

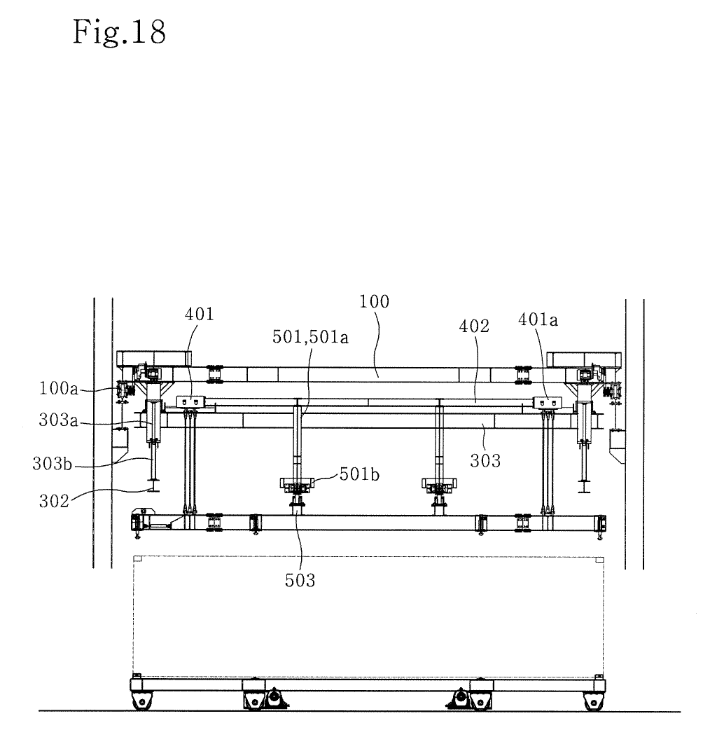

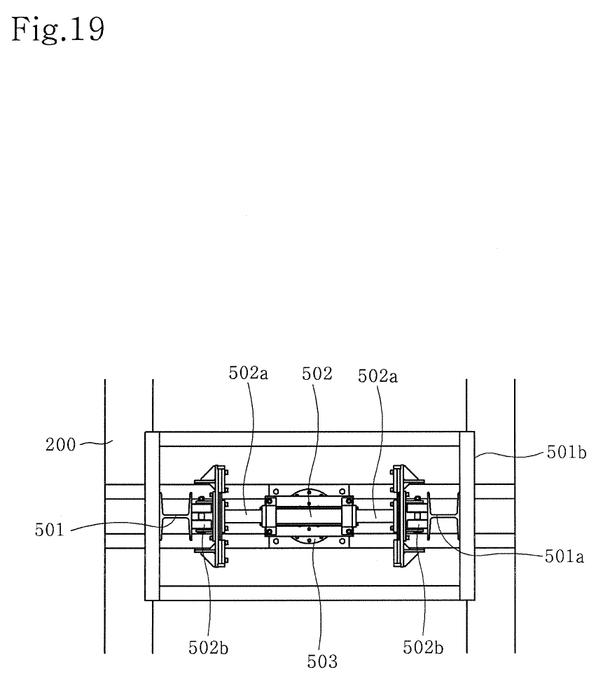

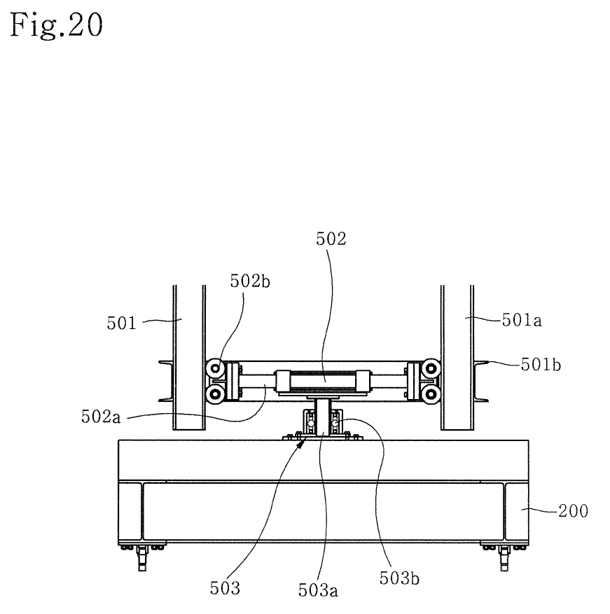

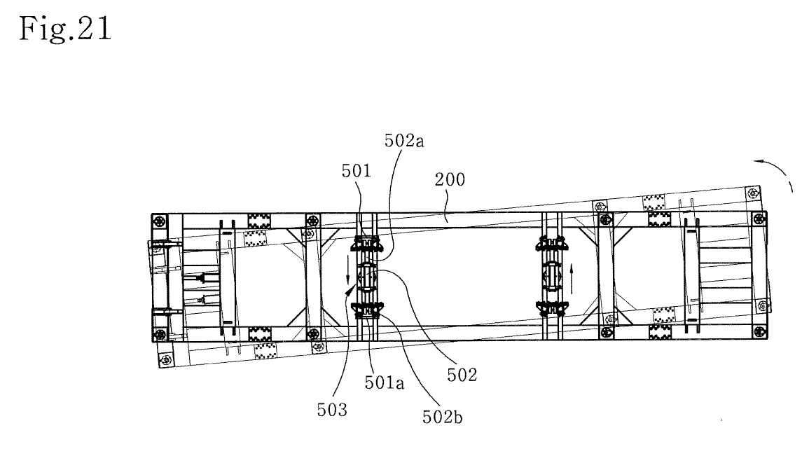

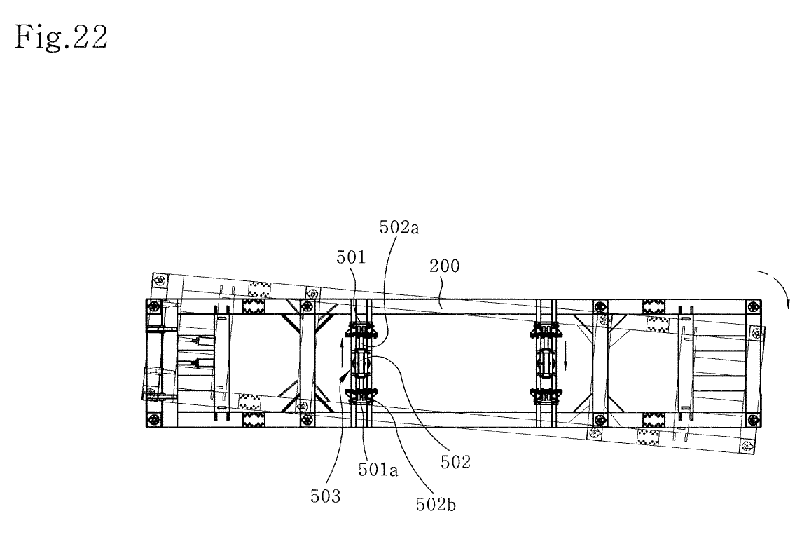

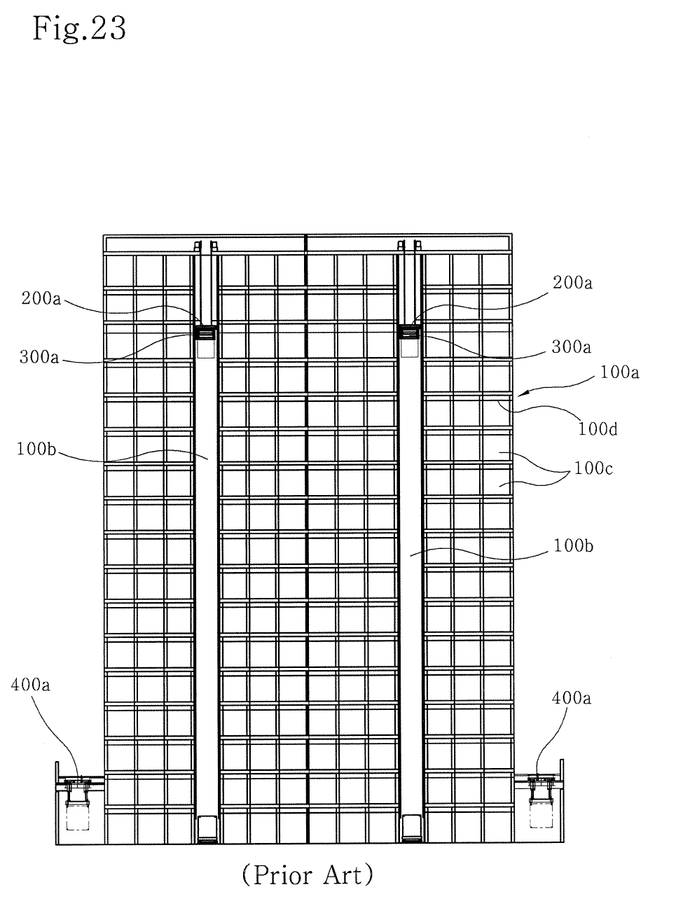

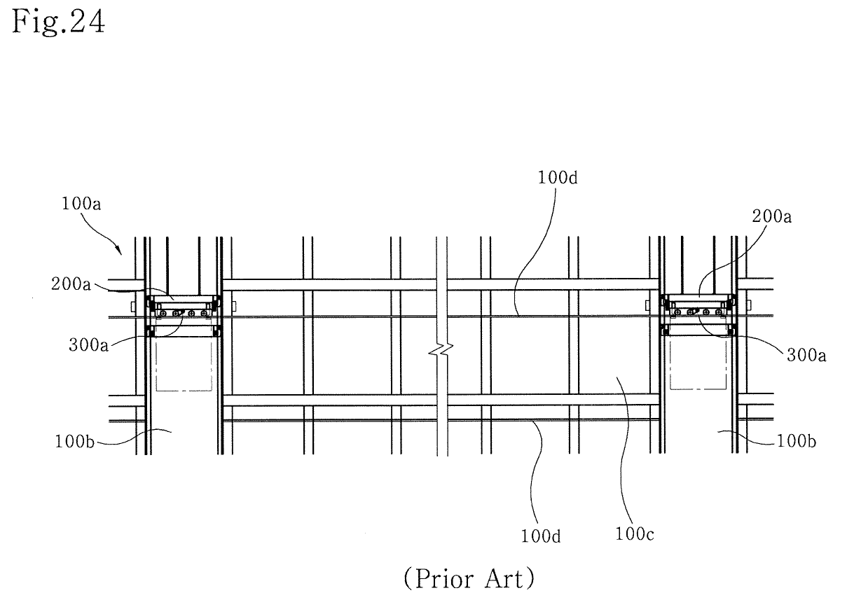

In the supporting beams 302 of the guide beams 301 and 301a, as shown in FIGS. 14 and 15, elevation frames 303 are provided to travel vertically. The elevation frames 303 are structured such that elevation cylinders 303a, whose rods 303b are connected to the supporting beams 302 of the guide beams 301 and 301a, are vertically installed to elevate and lower the elevation frames 303 along the guide beams 301 and 301a, and the spreader 200 as shown in FIG. 17 is connected to the lower sides of the elevation frames by wire ropes 303c.

Moreover, the horizontal transferring device 400, as shown in FIGS. 14, 16, and 18, is structured such that a pair of movable frames 401 and 401a is provided at the upper lateral sides of the elevation frames 303 perpendicular to the elevation frames 303 and the movable frames 401 and 401a are interconnected by a connection frame 402. The movable frames 401 and 401a are moved horizontally along guide rails 303d of the elevation frames 303 by active cylinders 403 whose ends are fixed to the elevation frames 303 and whose other ends are fixed to the movable frames 401 and 401a.

The positioning device 500 is structured such that a pair of vertical beams 501 and 501a is integrally and vertically formed at the lower lateral sides of the connection frame 402 installed between the movable frames 401 and 401a to face each other and the lower sides of the vertical beams 501 and 501a are supported by horizontal supporting frame 501b.

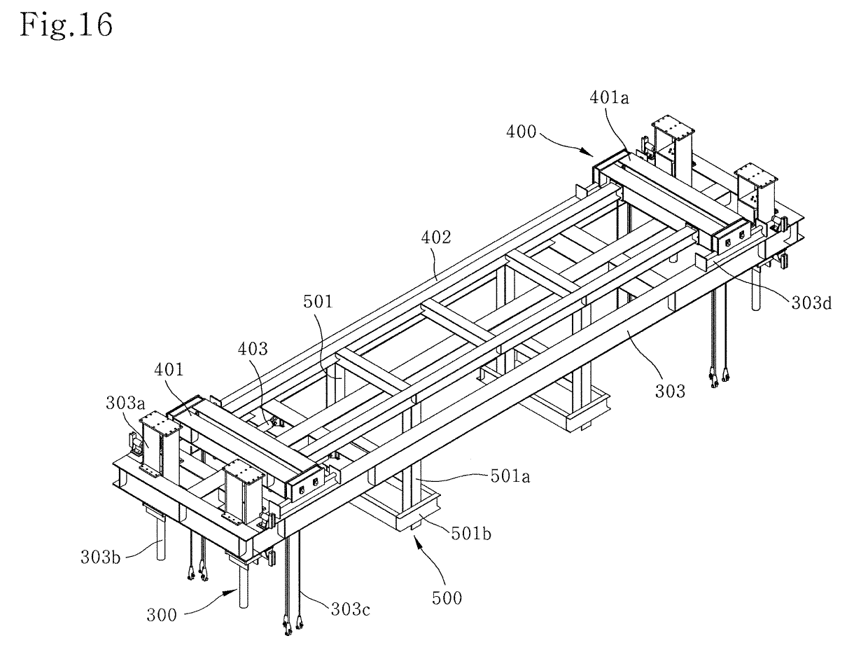

Between the vertical beams 501 and 501a of the positioning device 500, as shown in FIGS. 16, 17, and 19, tube cylinders 502 are provided and separated from the spreader 200. Each of the tube cylinders 502 travels along rods 502a in which rollers 502b are brought into rolling contact with the vertical beams 501 and 501a and are installed to the lateral sides of the rods 502a. The spreader 200 includes rotation devices 503 for fixing the tube cylinders 502 to the spreader 200 so as to rotate.

Each of the rotation devices 503, as shown in FIG. 20, includes a vertical rotation shaft 503a integrally formed with the lower side of the tube cylinder 502 and a bearing 503b for supporting the rotation shaft 503a against the spreader 200 to rotate.

The apparatus for storing and transferring containers structured as described above, as shown in FIG. 14, is moved along the guide rails 303d by the horizontal driving device 100a provided at the lateral sides of the loader main body 100. The spreader 200 can be vertically moved by elevating and lowering the elevation frames 303 of the elevation driving device 300. The rods 303b elevate and lower the elevation frames 303 by the elevation cylinders 303a fixed to the supporting beams 302. Since the spreader 200 is connected to the elevation frames 303 by the wire ropes 303c, the spreader 200 is elevated and lowered together the elevation frames 303.

As shown in FIGS. 14 and 16, the spreader 200 is horizontally moved by which the movable frames 401 and 401a connected to the spreader 200 by the wire ropes 303c are moved along the guide rails 303d by the active cylinders 403.

Moreover, the spreader 200 is twisted by the tube cylinders of the positioning device 500. As shown in FIGS. 20 and 21, when one 502 of the tube cylinders 502 and the other 502 thereof are moved along the rods 502a to the opposite sides, the vertical beams 501 and 501a contacting the rollers 502b by the rods 502a become fixed points and a linear force is transmitted to the spreader 200 so that the spreader 200 rotates about the rotation device 503 in a direction (here, counterclockwise), and when the tube cylinders 502 rotate in a direction opposite to the above-mentioned direction, as shown in FIG. 22, the spreader 200 rotates in the direction opposite to the direction in FIG. 21.

Since the left and right sides of the tube cylinders 502 are fixed by the vertical beams 501 and 501a and the tube cylinders 502 are fixed to the rotation device 503 to rotate, the spreader 200 can be fixed to be prevented from rotating.

As described above, according to the apparatus for storing and transferring container of the present invention, since the containers are rationally stored and withdrawn within the shorted time, time for storing and withdrawing the containers is significantly shortened so that a great deal of the containers is easily handled and the efficiency of storing and withdrawing the containers is significantly increased.

Moreover, since the apparatus stores and withdraws the containers using devices able to be used in a rational and speedy manner by checking whether or not all devices are out of order, the efficiency of storing and withdrawing the containers is remarkably increased.

Additionally, since the storages are expanded to the upper and lower sides of the apparatus, the efficiency of storing the containers is increased and the utility of the apparatus is improved. Thus, the storing and the withdrawal of the containers are effectively carried out and the stored containers are easily and effectively managed and handled.

Moreover, since the containers are smoothly transferred within the storages in the vertical direction by a simple structure, manufacture and installation of the apparatus are convenient and the efficiency of transferring the containers is increased.

The stopped cages are effectively transferred so that the capacity of unloading the container is significantly increased and the speed and the efficiency of unloading the containers are increased.

Since the loader is not shaken due to wind and the vertical movement and the swing of the loader are enabled, the loader is prevented from being swung due to wind and the vertical movement, the forward and backward movement, and the twist of the loader are enabled so as to easily fix the containers.

What is claimed is:

1. A method of storing and transferring containers in a tower type container storing system comprising the steps of:
designating a position where a container to be stored is stored when the container enters a steel structure;
elevating the container to a storage in a layer at the storing position along an elevation passage of the steel structure with a traveler;
transferring and temporally storing the container to and in a temporary storing place positioned at the leading end of the storage when the container is positioned in the storage; and
transferring and storing the container in the temporary storing place to and in a designated storing position using a transferring traveler installed in the storage.

2. The method of storing and transferring containers as set forth in claim 1, further comprising the step of transferring the traveler at the temporary storing place to a place where the container enters through the elevation passage to transfer other containers when the container is temporally stored after the temporary storing step.

3. The method of storing and transferring containers as set forth in claim 1, further comprising the step of checking whether or not a transferring traveler for transferring the container within the storage is out of order after the storing position designating step.

4. The method of storing and transferring containers comprising the steps of:
checking a position of a container, to be withdrawn, in a steel structure when the container to be withdrawn is designated;
transferring and temporally storing the container to and in a temporary storing place positioned at the leading end of a storage using a transferring traveler installed in a storage where the container to be withdrawn is stored;
lowering the container stored in the temporary storing place to a withdrawal position along the elevation passage of the steel structure using a traveler; and
withdrawing the container out of the steel structure when the container is arrived at the withdrawal position at the lower end of the elevation passage of the steel structure.

5. The method of storing and transferring containers as set forth in claim 4, further comprising the step of arranging other containers surrounding the container to be withdrawn by controlling the transferring traveler such that the container to be withdrawn is smoothly transferred before the step of temporally storing the container.

6. The method of storing and transferring containers as set forth in claim 4, further comprising the step of checking whether or not the transferring traveler for transferring the container within the storage, where the container to be withdrawn is stored, is out of order after the step of checking the withdrawal position of the container.

7. A method of storing and transferring containers in a tower type container storing system, comprising the steps of:
transferring containers to two cages which are then simultaneously elevated and lowered to store and to withdraw the containers using carts traveling along rails installed in the lower end of elevation passages, and transferring other containers to cages other than the two cages using auxiliary carts provided in the lowermost layer of storages of a steel structure and traveling along auxiliary rails parallel to the carts; and
transferring containers to the auxiliary carts and the other cages by horizontally moving travelers of the other cages through auxiliary horizontal rails installed in the lowermost layer of the storages where the auxiliary carts wait.

8. The method of storing and transferring containers in a tower type container storing system as set forth in claim 7, wherein the containers are transferred to the other cages by outer auxiliary carts traveling along the outer auxiliary rails, which are installed in traveling paths formed in the lowermost outer side of the steel structure, parallel to the carts; and
the containers are transferred between the outer auxiliary carts and the other cages by which travelers of the other cages horizontally travel along outer auxiliary horizontal rails which cross over each other from the traveling paths to the lower ends of the elevation passages.

9. In a tower type container storing system including a tower type steel structure having a plurality of storages formed in the lateral sides of elevation passages, and travelers moving horizontally in the cage along horizontal rails in the storages, an apparatus for storing and transferring containers in a tower type container storing system, comprising:
a temporary storing space at the lateral sides of the storages where a container transferred by the traveler is temporally stored or a container withdrawn from the storages is temporally stored; and
transferring travelers provided in the respective storages to transfer the containers stored in the temporary storing space to designated positions in the storages, to transfer the containers, to be withdrawn, in the storages to the temporary storing space, and traveling along the horizontal rails.

10. The apparatus for storing and transferring containers in a tower type container storing system as set forth in claim 9, wherein the storages have expanded vertical widths such that the plural containers are stored in vertical multiple layers; and
each of the transferring travelers includes:
a main body traveling along the horizontal rails and having driving wheels placed on the horizontal rails and a driving motor for driving the driving wheels;
a gripping frame provided in the lower side of the main body and having a hook for gripping the container; and
a vertical mover installed between the main body and the gripping frame to move the gripping frame in the vertical direction.

11. The apparatus for storing and transferring containers in a tower type container storing system as set forth in claim 10, wherein the vertical mover comprises:
a pair of first links having upper ends hinged to the lower lateral sides of the main body;
a pair of second links having upper ends hinged to the lower ends of the first links and lower ends hinged to the upper lateral sides of the gripping frame; and
a pair of hydraulic cylinders installed at an angle and having lower ends hinged to the central portions of the first links and upper ends hinged to the central portion of the main body.

12. The apparatus for storing and transferring containers in a tower type container storing system as set forth in claim 11, wherein the vertical mover further comprises a pair of supporting shafts hinged to the center portions of the first links to interconnect the first links horizontally and coupled with the lower ends of the hydraulic cylinders so as to be hinged.

13. The apparatus for storing and transferring containers in a tower type container storing system as set forth in claim 11, wherein the vertical mover further comprises a hinge shaft for horizontally connecting the first links and the second links to the hinged portions of the first links and the second links such that the lower ends of the first links are hinged to the upper ends of the second links.

14. The apparatus for storing and transferring containers in a tower type container storing system as set forth in claim 10, further comprising a plurality of auxiliary rails installed in the storages such that the travelers move to the lower sides of the horizontal rails corresponding to the number of the containers to be stored.

15. In a tower type container storing system including a tower type steel structure having a plurality of storages formed in the lateral sides of elevation passages, travelers horizontally moving in the cage along horizontal rails in the storages, carts provided in the lower ends of the elevation passages to travel along rails to transfer containers, and a loader installed outside of the steel structure to load and to unload the contained on and from the carts, an apparatus for storing and transferring containers in a tower type container storing system, comprising:
auxiliary rails installed in the lowermost layer of the steel structure parallel to the sides of the rails;
auxiliary carts traveling along the auxiliary rails to transfer the containers; and
auxiliary horizontal rails installed in the lowermost layer of the steel structure such that the travelers horizontally travel along the auxiliary rails.

16. The apparatus for storing and transferring containers in a tower type container storing system as set forth in claim 15, further comprising:
traveling paths provided outside of the steel structure parallel to the rails;
outer auxiliary rails installed in the inner lower sides of the traveling paths parallel to the rails;
outer auxiliary carts traveling along the outer auxiliary rails to transfer the containers; and
outer auxiliary horizontal rails installed from the lowermost outer side of the steel structure to the inner sides of the traveling paths.

17. The apparatus for storing and transferring containers in a tower type container storing system as set forth in claim 15, wherein the loader comprises:
a loader main body moving along the rails by horizontal driving units;
a spreader provided in the lower side of the loader main body and having a holding device;
an elevation driving device for moving the spreader by a driving power;
a horizontal transferring device for horizontally moving the spreader perpendicular to the loader main body; and
a positioning device for fixing the spreader to the horizontal transferring device and for twisting the same.

18. The apparatus for storing and transferring containers in a tower type container storing system as set forth in claim 17, wherein the elevation driving device comprises:
a pair of guide beams vertically installed at lateral lower sides of the loader main body to face each other and interconnected by supporting beams; and
elevation frames elevated and lowered along the guide beams by vertically installed elevation cylinders, having rods connected to the supporting beams which are installed to the guide beams, and connected to the spreader in the lower sides thereof by wire ropes.

19. The apparatus for storing and transferring containers in a tower type container storing system as set forth in claim 18, wherein the horizontal transferring device comprises:
a pair of movable frames provided at the upper lateral sides of the elevation frames perpendicular to the elevation frames and interconnected by connection frames; and
active cylinders having ends fixed to the elevation frames and other ends fixed to the elevation frames.

20. The apparatus for storing and transferring containers in a tower type container storing system as set forth in claim 19, wherein the positioning device comprises:
a pair of vertical beams integrally and vertically formed at the lower lateral sides of the connection frame to face each other and supported by horizontal supporting frame;
tube cylinders provided between the vertical beams, traveling along rods in which rollers are brought into rolling contact with the vertical beams and are installed to the lateral sides of the rods; and
rotation devices for fixing the tube cylinders to the spreader to rotate.

21. The apparatus for storing and transferring containers in a tower type container storing system as set forth in claim 20, wherein each of the rotation devices comprises:
a vertical rotation shaft integrally formed with the lower side of the tube cylinder; and
a bearing for supporting the rotation shaft against the spreader to rotate.
